(19) United States
(12) Patent Application Publication
(10) Pub. No.: US 2001/0022846 A1
(43) Pub. Date: Sep. 20, 2001

(54) Speaker parts and method of fabricating the speaker parts

(75) Inventors: Toshihiro Ishigaki, Yamagata-ken (JP); Yoshitaka Kobayashi, Yamagata-ken (JP)

Correspondence Address: ARENT FOX KINTNER PLOTKIN & KAHN, 1050 CONNECTICUT AVENUE, N.W., SUITE 600, WASHINGTON, DC, 20036, US

(73) Assignee: Pioneer Corporation; Tohoku Pioneer Corporation

(21) Appl. No.: 09/797,993

(22) Filed: Mar. 5, 2001

(30) Foreign Application Priority Data
Mar. 14, 2000 (JP) 2000-70411

(51) Int. Cl. H04R 1/00; H04R 11/02

(52) U.S. Cl. 381/398; 381/396

(57) ABSTRACT

Poly-norbornene based rubber is foamed and expanded to mold a speaker foamed-rubber edge. Short fibers are blended into the poly-norbornene based rubber to have orientation in the radial direction of the edge.

### BACKGROUND OF THE INVENTION

1. Field of the Invention

The invention relates to speaker parts, particularly, parts for a vibrating system of a speaker, and a method of fabricating the parts.

2. Description of the Related Art

Speakers typically use an edge for supporting a diaphragm, and the like, as vibrating system parts.

The vibrating system parts of the speaker, for example, the edge, have a direct effect on the operation of the diaphragm. Accordingly, the edge needs to satisfy certain exacting conditions: to be outstanding in linearity to absorb unnecessary vibration of the diaphragm, to have a high internal loss, to have sufficient strength while being light in weight, and so on.

Conventionally, in order to reduce the weight of the vibrating system of the speaker, such a speaker edge is made mainly of foamed rubber materials of a SBR (styrene-butadiene-rubber) type or an EPDM (ethylene-propylene-ethylenenorbornene) type.

However, the foamed rubber edges made of such foamed rubber materials have the disadvantage of lower strength and rigidity than an edge made of a solid rubber. Moreover, the edge made of the SBR type foamed rubber has the disadvantage of degradation in low-temperature resistance and light resistance, and also the edge made of the EPDM type foamed rubber has the disadvantage of being difficult to accomplish favorable frequency characteristics due to a low internal loss.

In short, conventional foamed rubber edges have the disadvantage of being difficult to apply to a high-power speaker and a vehicle-mounted speaker which is used in a hostile environment.

### SUMMARY OF THE INVENTION

The present invention has been made to solve the above disadvantages associated with the vibrating system parts for the speaker molded out of the conventional foamed rubber materials as described above.

It is therefore a first object of the present invention to provide vibrating system parts for a speaker which are capable of being effortlessly applied to a high-power speaker and a vehicle-mounted speaker.

It is a second object of the present invention to provide a method of fabricating vibrating system parts for a speaker which are capable of being smoothly applied to a high-power speaker and a vehicle-mounted speaker.

To attain the first object, speaker parts according to a first invention is characterized by molding foamed poly-norbornene rubber produced by foaming poly-norbornene based rubber.

The speaker parts according to the first invention is fabricated by molding the poly-norbornene based rubber. Therefore, the weight of parts is reduced. This reduces the weight of the vibrating system of the speaker, resulting in increase of sound pressure output from the speaker.

Moreover, the poly-norbornene based rubber has high strength even after foaming and also has the increased environmental resistance. Therefore, this allows the application of the foamed-rubber made-edge to a high-power speaker and a vehicle-mounted speaker, which is difficult conventionally. Moreover, due to the large internal loss of the materials, the poly-norbornene based rubber can minimize excrescent vibration of the diaphragm of the speaker and resonance of the part itself. Hence, it is possible to fabricate the speaker having appropriate frequency characteristics for flat sound qualities.

To attain the first object, the speaker parts according to a second invention is characterized, in addition to the configuration of the first invention, in that an edge for the speaker is molded out of the foamed poly-norbornene rubber.

Due to the above configuration, the strength and environmental resistance of the edge can be maintained even when the edge supporting the diaphragm of the speaker is formed of the foamed rubber.

To attain the first object, the speaker parts according to a third invention is characterized, in addition to the configuration of the first invention, in that the foamed poly-norbornene based rubber is blended with fibers.

The blending of the fibers into the poly-norbornene based rubber increases rigidity of the speaker parts. Due to the increased rigidity, the abnormal movement of the vibrating system of the speaker is reduced, resulting in allowing the fabrication of the fairly reliable speakers.

To attain the first object, the speaker parts according to a fourth invention is characterized, in addition to the configuration of the third invention, in that the fibers are oriented in a required direction inside the foamed poly-norbornene rubber.

This configuration increases the rigidity of the speaker parts in the direction of the orientation of the fibers.

To attain the first object, the speaker parts according to a fifth invention is characterized, in addition to the configuration of the third invention, in that the fibers blended into the foamed poly-norbornene rubber are one kind or two kinds or more of fibers selected from the group consisting of aramid fibers, polyester fibers, carbon fibers, PBO fibers and cotton fibers.

The blending of the fibers increases rigidity of the speaker parts.

To attain the first object, the speaker parts according to a sixth invention is characterized, in addition to the configuration of the third invention, in that the edge for the speaker is molded out of the foamed poly-norbornene rubber, and the fibers blended into the foamed poly-norbornene rubber are oriented in the radial direction of the edge for the speaker.

Since the poly-norbornene based rubber is blended with the fibers and the blended fibers are oriented in the radial direction of the speaker edge, the rigidity of the speaker parts in the direction of the orientation of the fibers is increased. Accordingly, the abnormal movement of the diaphragm of the speaker is reduced, resulting in allowing the fabrication of the fairly reliable speakers.

To attain the second object, a method of fabricating speaker parts according to a seventh invention is characterized by the steps of charging poly-norbornene based rubber blended with fibers into a mold; and heat-pressing the poly-norbornene based rubber using the mold to foam and expand the poly-norbornene based rubber to mold the foamed poly-norbornene rubber in a required shape for the speaker parts.

According to the method of fabricating the speaker parts of the seventh invention, the foam molding of the speaker parts with reduced weight, high strength and high environmental resistance using the poly-norbornene based rubber is allowed.

To attain the second object, the method of fabrication speaker parts according to an eighth invention is characterized, in addition to the configuration of the seventh invention, in that the poly-norbornene based rubber blended with the fibers is heat-pressed using the mold to mold an edge for the speaker.

Due to the configuration, when the poly-norbornene based rubber is heat-pressed to flow inward and outward in the radial direction along the molding faces of the mold, the fibers blended into the poly-norbornene based rubber are oriented in the radial direction, resulting in allowing the fabrication of the speaker foamed rubber parts with the increased rigidity in the radial direction of the parts.

To attain the second object, the method of fabrication speaker parts according to an ninth invention is characterized, in addition to the configuration of the seventh invention, in that the fibers blended into the poly-norbornene based rubber are at least a kind of fibers selected from a group consisting of aramid fibers, polyester fibers, carbon fibers, PBO fibers and cotton fibers.

According to the method of fabricating the speaker parts of the ninth invention, in order to increase rigidity of the speaker parts which is molded, the poly-norbornene based rubber used in molding the speaker parts is blended with one kind or two kinds or more of fibers selected from the group consisting of aramid fibers, polyester fibers, carbon fibers, PBO (poly-para-phenylene-benzobis-oxazole) fibers, cotton fibers, and so on.

To attain the second object, a method of fabrication speaker parts according to a tenth invention is characterized by the steps: a first process of charging poly-norbornene based rubber into an openable pair of molds; a second process of closing a space between the molds, in which the poly-norbornene based rubber is charged, for heat-pressing the poly-norbornene based rubber; a third process of making a predetermined first degree of opening space between the pair of molds while the pressed poly-norbornene based rubber is being foamed and expanded; and a fourth process of reducing the space between the pair of molds to a predetermined second degree of opening after the space between the pair of molds has been opened up to the predetermined first degree of opening.

According to the method of fabricating the speaker parts of the tenth invention, in the first process, while the pair of molds is opened, the poly-norbornene based rubber is charged onto the molding face of the mold. After that, in the second process, the pair of molds is closed for pressing the poly-norbornene based rubber to press and extend the charged poly-norbornene based rubber along the molding faces of the pair of molds.

Then, the poly-norbornene based rubber is foamed by means of heating or the like. During the condition, in the third process, the pair of molds is opened to the predetermined first degree of opening.

This allows the readily and sufficiently foaming of the pressed poly-norbornene based rubber and also allows the extra gas evolved by the foaming to be released into the air from the space between the molds.

Then, in the fourth process, the space between the molds is reduced to the predetermined second degree of opening for molding the speaker parts having a required thickness.

As described above, according to the tenth invention, since the speaker parts are molded by means of the multistage foam molding, it becomes possible to foam (expansion)-mold the poly-norbornene based rubber having a required hardness, which is impossible in conventional molding methods.

Further, the selectively determining of the degree of opening and closing the space between molds and the maintaining time in each process, allows the effortless adjusting of the thickness, specific gravity, physical properties and so on of the speaker parts without replacing the molds, changing additive to the poly-norbornene based rubber, and so on.

Still further, since in the foaming of the poly-norbornene based rubber, the degree of opening the space between the molds is increased for releasing the gas from the space between the molds, it is possible to eliminate or decrease the need for the degassing of the mold.

Since in the foam molding, the extra gas is removed, it is avoided that air-bubbles may remain in the surface of the speaker part to impair the appearance and that the speaker parts cannot be perfectly molded.

To attain the second object, the method of fabrication speaker parts according to a eleventh invention is characterized, in addition to the configuration of the tenth invention, in that the poly-norbornene based rubber blended with the fibers is heat-pressed using the mold to mold an edge for the speaker.

With this configuration, when the poly-norbornene based rubber is heat-pressed and flows inward and outward in the radial direction along the molding faces of the molds, the fibers blended into the poly-norbornene based rubber are oriented in the radial direction, resulting in allowing the fabrication of the speaker foamed rubber edges having the increased rigidity in the radial direction.

To attain the second object, the method of fabrication speaker parts according to a twelfth invention is characterized, in addition to the configuration of the tenth invention, in that at least a kind of fibers selected from a group consisting of aramid fibers, polyester fibers, carbon fibers, PBO fibers and cotton fibers are blended into the poly-norbornene based rubber.

According to the method of fabricating the speaker parts of the twelfth invention, in order to increase rigidity of the speaker parts which is molded, the poly-norbornene based rubber used in molding the speaker parts is blended with one kind or two kinds or more of fibers selected from the group consisting of aramid fibers, polyester fibers, carbon fibers, PBO fibers, cotton fibers, and so on.

To attain the second object, the method of fabrication speaker parts according to a thirteenth invention is characterized, in addition to the configuration of the tenth invention, in that, in the second process, the pair of molds are maintained at the closed condition for a predetermined first set time.

According to the method of fabricating the speaker parts of the thirteenth invention, the pair of molds are closed from the condition in the first process and maintained at the closed condition for the predetermined first set time that is sufficient time for the poly-norbornene based rubber to be fully foamed in the second process.

To attain the second object, the method of fabrication speaker parts according to a fourteenth invention is characterized, in addition to the configuration of the tenth invention, in that, in the third process, the pair of molds are maintained at the open condition for a predetermined second set time.

According to the method of fabricating the speaker parts of the fourteenth invention, the pair of molds are open from the condition in the second process and maintained at the open condition for the predetermined second set time that is sufficient time for the extra gas to be evolved from the foamed poly-norbornene based rubber.

To attain the second object, the method of fabrication speaker parts according to a fifteenth invention is characterized, in addition to the configuration of the tenth invention, in that, in the fourth process, the pair of molds are maintained at the condition that the space between the pair of molds is reduced for a predetermined third set time.

According to the method of fabricating the speaker parts of the fifteenth invention, the space between the pair of molds is reduced from the condition in the third process and maintained at the condition for the predetermined third set time that is sufficient time for the foamed rubber to be completely vulcanized to mold the speaker parts in a predetermined shape.

These and other objects and advantages of the present invention will become obvious to those skilled in the art upon review of the following description, the accompanying drawings and appended claims.

### BRIEF DESCRIPTION OF THE DRAWINGS

FIG. 1 is a diagram showing a synthetic reaction scheme of norbornene.

FIG. 2 is a diagram showing a synthetic reaction scheme of poly-norbornene.

FIG. 3 is a graph showing tensile strength of ploy-norbornene rubber.

FIG. 4 is a graph showing the level of temperature dependence of a loss factor of poly-norbornene rubber.

FIGS. 5A to 5C are process diagrams showing an example of an embodiment of a fabricating method according to the present invention.

FIG. 6 is a perspective view a foamed rubber edge for a speaker molded by the fabricating method.

FIG. 7 is a table showing acoustically physical properties of poly-norbornene rubber.

FIG. 8 is a diagram for explaining the first process in another example of the embodiment of the fabricating method according to the present invention.

FIG. 9 is a diagram for explaining the second process of the fabricating method in FIG. 8.

FIG. 10 is a diagram for explaining the third process of the fabricating method in FIG. 8.

FIG. 11 is a diagram for explaining the fourth process of the fabricating method in FIG. 8.

### DETAILED DESCRIPTION OF THE PREFERRED EMBODIMENT

Most preferred embodiment according to present invention will be described taking an edge of vibrating system parts for a speaker as an example.

An edge for a speaker in the embodiment is molded by foam molding using poly-norbornene rubber as a base material.

The distinctive points of the poly-norbornene rubber include high strength, a high internal loss, retention of the high strength even after being foamed, and high environmental resistance such as low-temperature resistance, light resistance and so on.

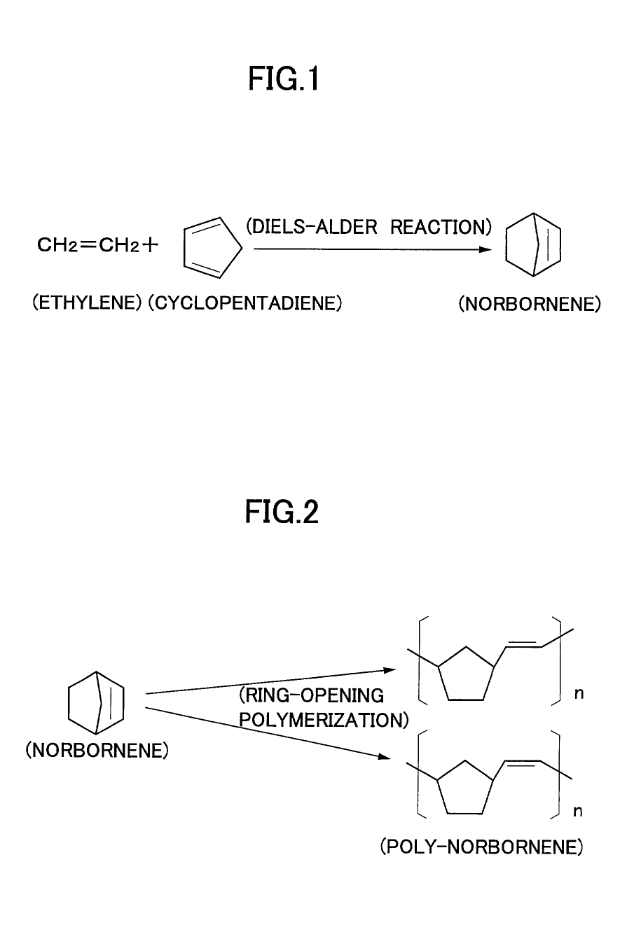

For the poly-norbornene rubber, as shown in FIG. 1, norbornene is synthesised from ethylene and cyclopentadiene by Diels-Alder reaction (diene synthesis). Then, as shown in FIG. 2, the norbornene undergoes ring-opening polymerization to form a polymer which is base of the poly-norbornene rubber. The polymer can be utilized as a rubber material on which viscoelastic properties, in particular, a controlled damping property and elastic properties are controlled by adding an oil of aromatic series or medium-viscosity naphthene series or an oil of paraffin series or low-viscosity naphthene series.

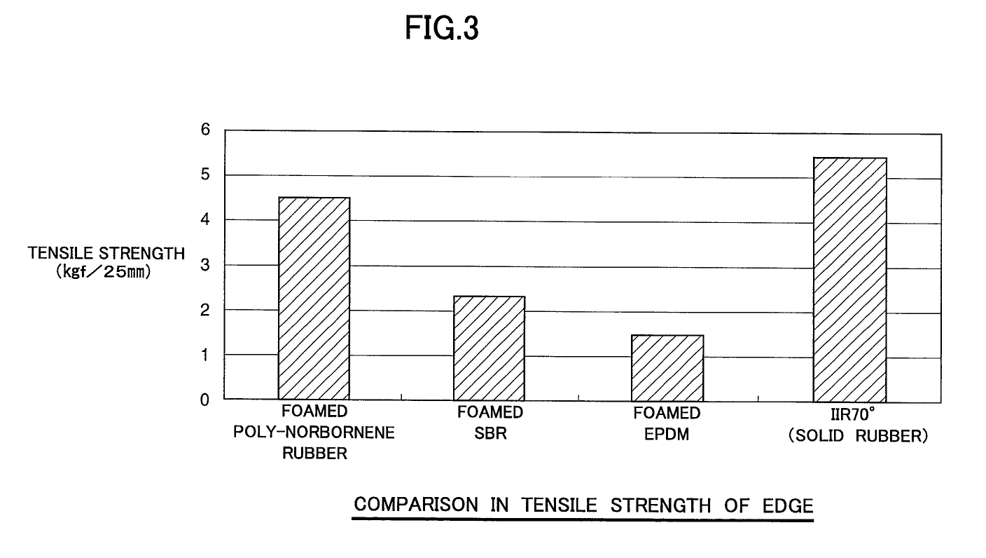

FIG. 3 is a graph showing the comparison in tensile strength of foamed poly-norbornene rubber, foamed SBR, foamed EPDM and IIR (isobutylene-isoprene rubber) of solid rubber.

As is clear from FIG. 3, it is seen that the foamed poly-norbornene rubber has a tensile strength higher than those of foamed SBR and foamed EPDM, and comparable with that of IIR.

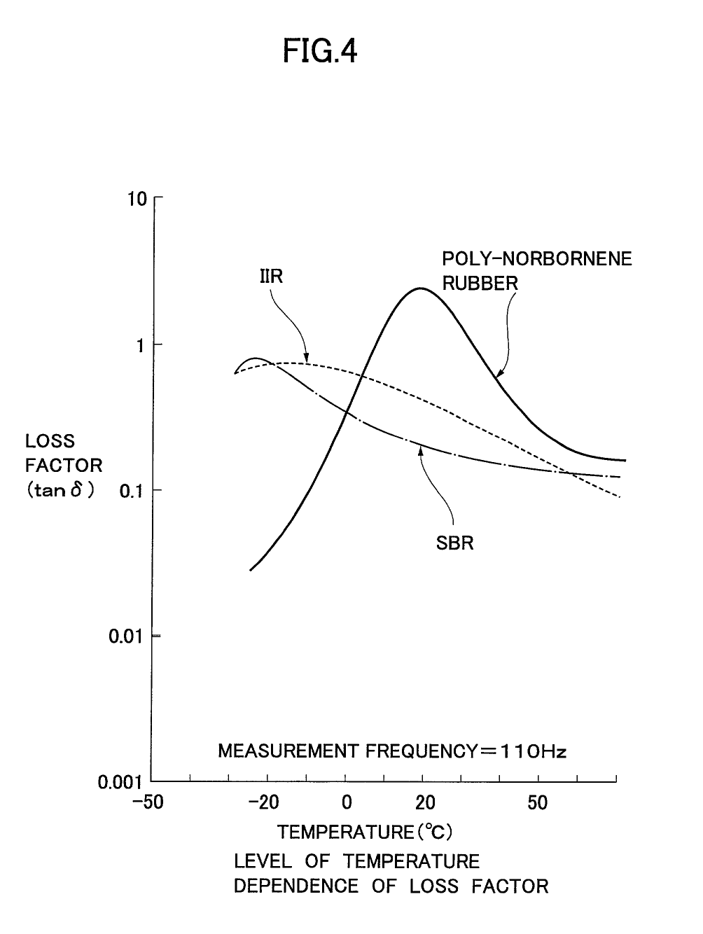

FIG. 4 is a graph showing the level of temperature dependence of a loss factor of the poly-norbornene rubber. It is seen from FIG. 4 that in comparison with those of SBR and IIR, the poly-norbornene has a larger loss factor at temperatures greater than or equal to 0° C.

The following explanation is made for a method of molding a speaker edge using unvulcanized rubber containing the aforementioned poly-norbornene rubber as a base material.

In order to increase rigidity of the edge which is molded, the unvulcanized rubber compound used in molding the speaker edge is blended with one kind or two kinds or more of short-fibers selected from the group consisting of aramid fibers, polyester fibers, carbon fibers, PBO (poly-para-phenylene-benzobis-oxazole) fibers, cotton fibers, and so on.

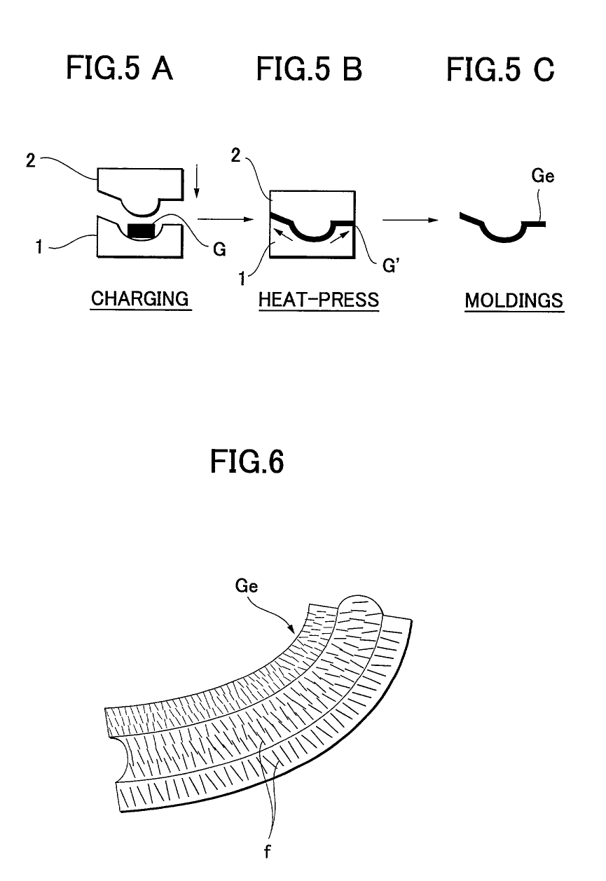

As shown in FIG. 5A, the unvulcanized rubber compound (the unvulcanized poly-norbornene rubber) G blended with short fibers is placed on a molding face of a stationary mold 1. Then, as shown in FIG. 5B, the rubber compound G is heat-pressed with a movable mold 2 to be foamed therein.

In the press process, furthermore, the rubber compound G′ is pressed by pressing pressure, thereby to flow inward and outward in the radial direction along the molding faces of the stationary mold 1 and the movable mold 2. In this event, the short fibers blended into the rubber compound G′ are oriented in the radial direction.

As a result of the foaming as described above, a foamed rubber edge (foamed poly-norbornene rubber) Ge for a speaker is fabricated as shown in FIG. 5C.

FIG. 6 shows orientation of the short fibers f, blended into the rubber compound of the speaker foamed-rubber edge(foamed poly-norbornene rubber) Ge molded by the above method, in the radial direction of the speaker foamed-rubber edge (foamed poly-norbornene rubber) Ge.

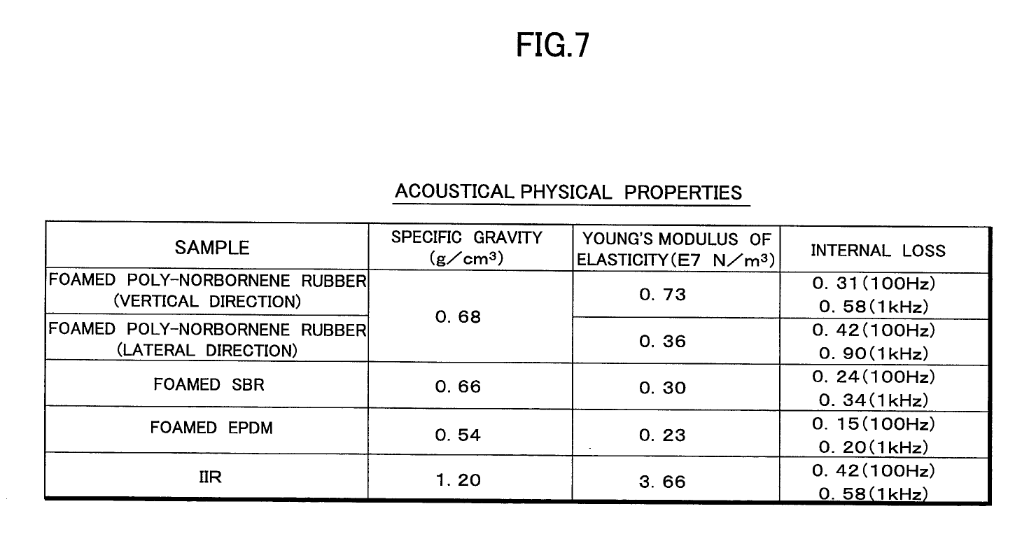

FIG. 7 shows the comparisons in the acoustical physical properties among the speaker foamed-rubber edge made of the foamed poly-norbornene rubber and molded as described above, and the rubber edges respectively made of the foamed SBR, foamed EPDM and IIR.

In FIG. 7, the vertical direction of the foamed poly-norbornene rubber means a direction of orientation of the short fibers (i.e. the radial direction of the speaker foamed-rubber edge), while the lateral direction means a direction orthogonal to the orientating direction of the short fibers (i.e. the circumferential direction of the speaker foamed-rubber edge).

It is seen from FIG. 7 that the speaker foamed-rubber edge made of the foamed poly-norbornene rubber has internal loss larger than those of the foamed-rubber edges, made of the foamed SBR and the foamed EPDM, in any frequency band in the range from 100 Hz to 1 kHz.

It is also seen that the speaker foamed-rubber edge made of foamed poly-norobornene rubber has approximately the same internal loss in the vertical direction as the internal loss of the IIR made-rubber edge, but has a specific gravity smaller than that thereof, that is the foamed poly-norbornene rubber made-edge has a reduced weight.

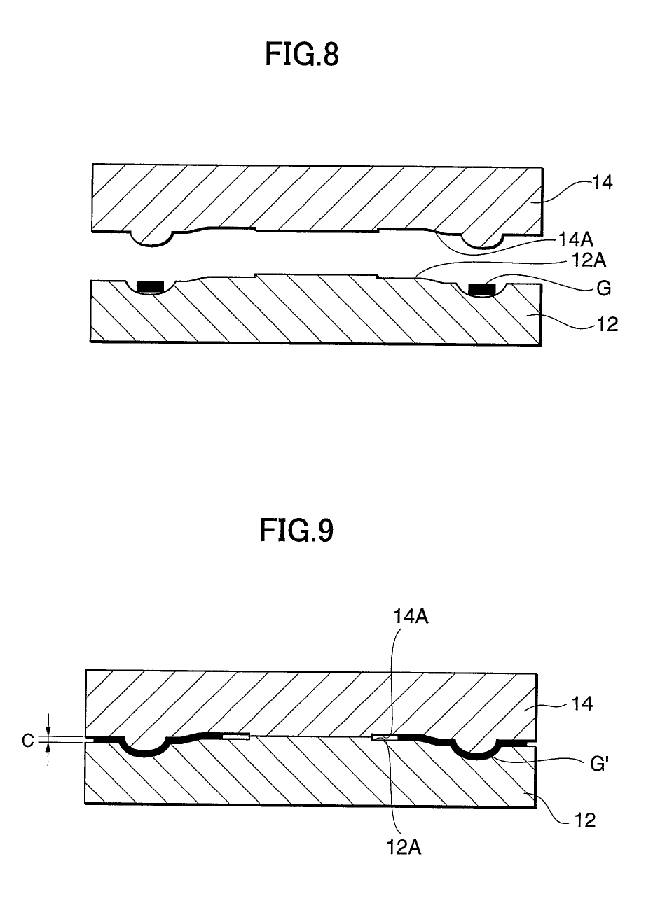

FIGS. 8 to 11 show processes of a multistage foaming technique of the speaker foamed-rubber edge.

The following explanation with reference to FIGS. 8 to 11 is made for a method of fabricating the speaker foamed-rubber edge in accordance with the multistage foaming technique.

Initially, in the first process in FIG. 8, a movable mold 14 is moved away from a stationary mold 12 to open up a molding face 12A of the stationary mold 12. Then, the unvulcanized rubber compound G containing the poly-norbornene rubber as the base material and blended with the short fibers as described above, is charged onto the molding face 12A of the stationary mold 12.

Then, in the second process in FIG. 9, the movable mold 14 moves toward the stationary mold 12 to close therebetween.

In this event, between the molding face 12A provided on the top surface of the stationary mold 12 and a molding face 14A of the bottom surface of the movable mold 14, a required clearance c is provided. The rubber compound G′ is pressed in the clearance c to form an edge shape along the molding faces 12A and 14A.

During the above condition, the rubber compound G′ is heated and maintained for a predetermined time period (a first set time).

The rubber compound G′ is foamed by the heating.

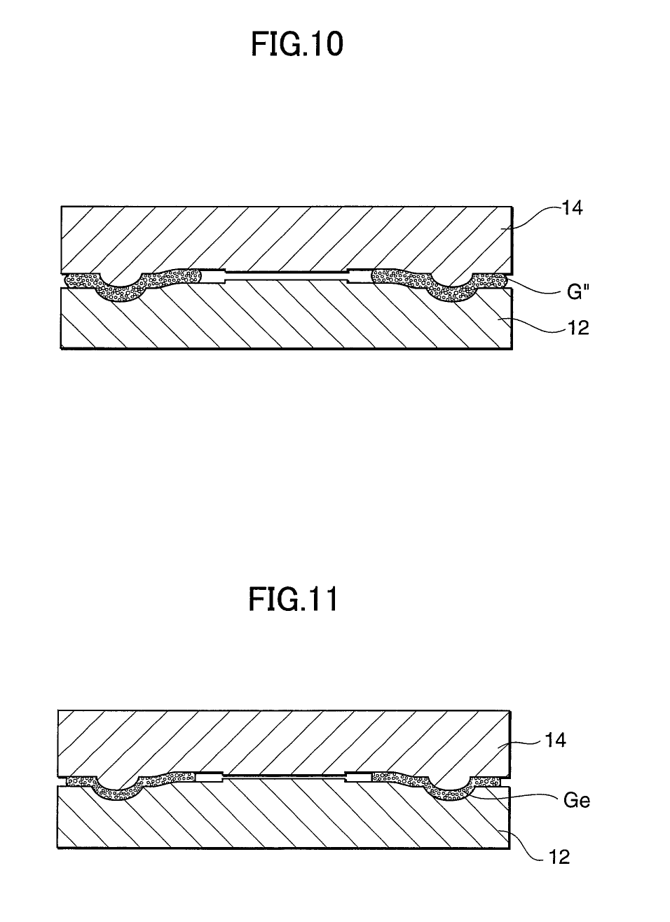

After the second process, in the third process in FIG. 10, the movable mold 14 moves away from the stationary mold 12 to a predetermined distance to establish a predetermined space between the stationary mold 12 and the movable mold 14.

The rubber compound G′ is maintained in the above condition for a predetermined time period (a second set time).

The above establishment of the predetermined space between the stationary mold 12 and the movable mold 14 allows the rubber compound (foamed poly-norbornene rubber) G″ pressed into the edge shape to foam readily and sufficiently, and also allows the extra gas evolved from the rubber compound G″ by the foaming to be released into the air from the space between the stationary mold 12 and the movable mold 14.

After the third process, in a fourth process in FIG. 11, the movable mold 14 is moved again toward the stationary mold 12 to a predetermined distance to reduce the space between the molds 12 and 14 to the predetermined distance.

The moving distance of the movable mold 14 is determined such that the thickness of the rubber compound sandwiched between the stationary mold 12 and the movable mold 14 will be the thickness of the speaker foamed-rubber edge Ge which is the resultant molding.

The rubber edge Ge is maintained in the above condition for a predetermined time period (a third set time).

In this way, the foamed rubber is completely vulcanized to mold the speaker foamed-rubber edge Ge in a predetermined shape.

After that, the movable mold 14 is moved for opening, and then the resultant speaker foamed-rubber edge Ge thus molded is removed from the stationary mold 12.

In order to adjust the degree of opening the space between the stationary mold 12 and movable mold 14 as explained above, a controller drive-controls a drive cylinder (not shown) operating the movable mold 14.

The molding of the foamed rubber by the multistage foaming technique as discussed above allows the foam molding of rubber having required hardness which is not achieved by conventional molding methods. Therefore, a foamed rubber edge having a hitherto unachieved degree of rigidity can be molded.

As described above, the use of poly-norbornene rubber as the base material to fabricate the speaker foamed-rubber edge by means of the foam molding, allows a reduction in the weight of the edge. This allows a reduction in the weight of the vibrating system of the speaker. Accordingly, it is possible to increase the sound pressure output from the speaker using the above foamed rubber edge.

The poly-norbornene rubber has high strength even after foaming and also has the increased environmental resistance. Therefore, this allows the application of the foamed-rubber edge to a high-power speaker and a vehicle-mounted speaker, which is difficult conventionally. Moreover, due to the large internal loss of the materials, the poly-norbornene rubber can minimize excrescent vibration of the diaphragm of the speaker and resonance of the edge itself. Hence, it is possible to fabricate the speaker having appropriate frequency characteristics for flat sound qualities.

In addition, the rubber compound blended with short fibers of aramid fibers, polyester fibers, carbon fibers, PBO fibers, cotton fibers and so on is molded using a mold by heat-pressing, so that the blended fibers are oriented in the radial direction in the edge, resulting in the foamed rubber edge with high rigidity. This allows the reduction of abnormal movement of the diaphragm and the fabrication of the speaker with a high degree of reliability.

The terms and description used herein are set forth by way of illustration only and are not meant as limitations. Those skilled in the art will recognize that numerous variations are possible within the spirit and scope of the invention as defined in the following claims.

What is claimed is:

1. Speaker parts comprising parts for vibrating system of a speaker molded out of foamed poly-norbornene rubber produced by foaming poly-norbornene based rubber.

2. The speaker parts according to claim 1, wherein said parts for the vibrating system include an edge and the edge is molded out of said foamed poly-norbornene rubber.

3. The speaker parts according to claim 1, wherein said foamed poly-norbornene rubber is blended with fibers.

4. The speaker parts according to claim 3, wherein said fibers are oriented in a required direction inside said foamed poly-norbornene rubber.

5. The speaker parts according to claim 3, wherein said fibers blended into said foamed poly-norbornene rubber are at least a kind of fibers selected from a group consisting of aramid fibers, polyester fibers, carbon fibers, PBO fibers and cotton fibers.

6. The speaker parts according to claim 3, wherein the edge for the speaker is molded out of said foamed poly-norbornene rubber, and the fibers blended into the foamed poly-norbornene rubber are oriented in the radial direction of the edge for the speaker.

7. A method of fabricating speaker parts including a method of fabricating vibrating system parts of a speaker, comprising the steps of:
charging poly-norbornene based rubber into a mold; and
heat-pressing the poly-norbornene based rubber using the mold to foam and expand the poly-norbornene based rubber to mold the foamed poly-norbornene rubber in a required shape for the speaker parts.

8. The method of fabricating the speaker parts according to claim 7, wherein the poly-norbornene based rubber blended with the fibers is heat-pressed using said mold to mold an edge for the speaker.

9. The method of fabricating the speaker parts according to claim 7, wherein the fibers blended into the poly-norbornene based rubber are at least a kind of fibers selected from a group consisting of aramid fibers, polyester fibers, carbon fibers, PBO fibers and cotton fibers.

10. A method of fabricating speaker parts of foam moldings including a method of fabricating vibrating system parts of the speaker, comprising the steps of:
a first process of charging poly-norbornene based rubber into an openable pair of molds;
a second process of closing the pair of molds, in which the poly-norbornene based rubber is charged, for heat-pressing the poly-norbornene based rubber;
a third process of making a predetermined first degree of opening a space between the pair of molds while the pressed poly-norbornene based rubber is being foamed and expanded; and
a fourth process of reducing the space between the pair of molds to a predetermined second degree of opening after the space between the pair of molds has been opened up to the predetermined first degree of opening.

11. The method of fabricating the speaker parts according to claim 10, wherein the poly-norbornene based rubber blended with the fibers is heat-pressed using said mold to mold an edge for the speaker.

12. The method of fabricating the speaker parts according to claim 10, wherein at least a kind of fibers selected from a group consisting of aramid fibers, polyester fibers, carbon fibers, PBO fibers and cotton fibers are blended into the poly-norbornene based rubber.

13. The method of fabricating the speaker parts according to claim 10, wherein, in the second process, the pair of molds are maintained at the closed condition for a predetermined first set time.

14. The method of fabricating the speaker parts according to claim 10, wherein, in the third process, the pair of molds are maintained at the open condition for a predetermined second set time.

15. The method of fabricating the speaker parts according to claim 10, wherein, in the fourth process, the pair of molds are maintained at the condition that the space between the pair of molds is reduced for a predetermined third set time.
